(19) United States
(12) Patent Application Publication
(10) Pub. No.: US 2009/0163354 A1
(43) Pub. Date: Jun. 25, 2009

(54) PURIFICATION STRUCTURE INCORPORATING AN ELECTROCHEMICAL CATALYSIS SYSTEM

(75) Inventors: Patricia Andy, Les Taillades (FR); Daniel Urffer, Saint-Saturnin (FR); William Mustel, Montmorency (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN CENTRE RECHERCHES ET D'ET EUROPEEN, COURBEVOIE (FR)

(21) Appl. No.: 12/295,900

(22) PCT Filed: Apr. 6, 2007
(86) PCT No.: PCT/FR2007/051090

§ 371 Date: Oct. 3, 2008

(30) Foreign Application Priority Data
Apr. 10, 2006 (FR) 0651287

(51) Int. Cl. B01J 29/068

(52) U.S. Cl. 502/66

(57) ABSTRACT

The invention relates to a structure for the purification of a contaminated gas, for example the exhaust gas from a diesel or petrol engine, the structure incorporating an electrochemical system for treating said gas, composed of an NOₓ reduction catalyst A, a hydrocarbon oxidation catalyst B, an electron-conducting compound C and an ion-conducting compound D, said structure being characterized in that it is made of or covered with at least one porous, inorganic, electron-conducting and/or ion-conducting material in such a way that the catalysts A and B are disposed in the porosity of the inorganic material and that the ion-conducting, electron-conducting or ion-conducting and electron-conducting inorganic material makes up, respectively, the element C, the element D, or the sum of the elements C and D of said electrochemical system.

The present invention relates to the field of structures for purifying a gas charged with gaseous contaminants, substantially of the NOₓ type. More particularly, the invention relates to honeycomb structures, in particular used for treating the exhaust gases of a diesel or gasoline engine, and incorporating a system combining a catalyst A for reducing said contaminant species of the NOₓ type and a catalyst B for oxidizing hydrocarbons HC and/or for oxidizing soot and/or for steam reforming reactions of the HC+H₂O→3/2H₂+CO type and/or for gas and water reactions of the CO+H₂O.il₂+CO₂ type.

The techniques and problems linked to the purification of contaminated gases, particularly leaving the exhaust lines of gasoline or diesel motor vehicles are well known in the art. A three-way conventional catalytic converter permits the conjoint treatment of NOₓ, CO and HC contaminants and their conversion into neutral and chemically non-harmful gases such as N₂, CO₂ and H₂O. Very good efficiency of the system is however only obtained by continually adjusting the richness of the air-fuel mixture. It is thus known that the slightest deviation in relation to the stoichiometry of the mixture causes a large increase in the emission of contaminants.

In order to solve this problem, it has been proposed to incorporate materials with the catalyst enabling NOₓ to be temporarily fixed (often called in the art NOₓ trap) when the mixture is lean (that is to say sub-stoichiometric). The main disadvantage of such a system is however that the reduction of NOₓ can only be achieved at the price of an over-consumption of fuel. The desorption of NOₓ trapped on the catalyst and its catalytic reduction into gaseous nitrogen N₂ can in fact only be obtained, with the reduction catalyst, by the presence of a sufficient quantity of reducing species in the form of hydrocarbons or carbon monoxide CO or gaseous hydrogen H₂. Gaseous hydrogen can itself be obtained by a catalytic reaction between hydrocarbons HC and steam or between CO and steam.

According to a different approach, U.S. Pat. No. 6,878,354 describes a combination of catalysts for oxidizing HC and CO and for reducing NOₓ electrochemically. Such systems appear to be advantageous since they permit the electrochemical reaction between the reduction catalyst A and oxidation catalyst B connected together both by an electron-conductor C and an ion-conductor D. According to this publication, such a system makes it possible in particular to increase catalytic conversion of contaminant species, in particular as an engine operates with a lean mixture.

In order to be efficient, such a system however requires the use of a substance adsorbing NOₓ and a substance adsorbing hydrocarbons HC.

According to a first embodiment described in this patent, the catalysts A and B are deposited on a metal support, mixed with an ion-conductor D. The metal support provides the electrons necessary for the satisfactory functioning of the electrochemical system. However, the use of such a support in an exhaust line of a motor vehicle, particularly diesel, is problematic essentially due to its low resistance to oxidation and its mediocre chemical resistance. In addition, this type of metal support has the main disadvantage of exhibiting low chemical and dilatometric compatibility with the catalysts, which should moreover incorporate, according to the teaching provided in U.S. Pat. No. 6,878,354, traps for No, or HC of the barium oxide, zeolites or other mixed oxides type, also with low chemical compatibility with the metal support.

According to a second embodiment described in U.S. Pat. No. 6,878,354, the four constituents A, B, C and D are introduced as a mixture on a non-conducting ceramic support consisting of cordierite.

The efficiency of such a system then strongly depends on the deposition conditions of the catalysts A and B and of the electron-conductors C and ion-conductors D. Indeed, the properties obtained are strongly dependent on the dispersion of the various phases corresponding to the various constituents on the support used, a connection being necessary between these four elements for the satisfactory operation of the electrochemical system. Finally, since the electrochemical system consists of small-size grains randomly deposited relative to each other, its efficiency is of necessity limited on the one hand by the connections between the grains and on the other hand by the small quantity of electrolytes (electrons and/or ions) available for the satisfactory operation of the electrochemical catalysis system.

Moreover, it is particularly known, for example from the publication EP 1 566 214, that ceramic oxide catalyst supports in particular of the cordierite type, may be degraded by DeNOₓ catalysts of the NOₓ trap type.

The object of the present invention is therefore to provide a solution enabling the previously described problems to be solved. In particular, one of the objects of the present invention is to provide a structure for the purification of a contaminated gas, in particular a structure for filtering an exhaust gas coming from a gasoline or diesel engine, charged with gaseous contaminants and solid particulates, capable of operating whatever the richness of the air/fuel mixture.

According to a first feature, the present invention relates to a structure, preferably a honeycomb structure, for the purification of a contaminated gas, for example an exhaust gas from a diesel or gasoline engine, incorporating an electrochemical system for treating said gas, consisting of:
a catalyst A for reducing contaminant species of the NOₓ type,
a catalyst B for oxidizing hydrocarbons HC,
an electron-conducting compound C,
an ion-conducting compound D,
   said catalysts A and B being in electronic contact via the compound C and in ionic contact via the compound D, said structure being characterized in that it consists of, or is covered by, at least one ion-conducting and/or electron-conducting porous inorganic material so that:
the catalysts A and B are deposited in the porosity of the inorganic material,
the electron-, ion- or ion- and electron-conducting inorganic material constitutes respectively the element C, the element D, or the sum of the elements C and D of said electrochemical system.

Within the meaning of the present invention, the porous inorganic material has an open porosity, measured conventionally by mercury porosimetry, greater than 10%, preferably greater than 20% or even greater than 30%.

The catalyst A used for the reduction reaction is chosen from catalysts well known in the art for their activity and preferably their selectivity as regards to reactions for reducing NOₓ. They may be chosen in particular from compounds of the alkali metal type or alkaline earth type or of the rare earths, which additionally act as an NOₓ trap, such as those described in application EP 1 566 214, deposited mixed with an active principle including precious metals (Pt, Pd, Rh) by adsorption at the surface of a powder of a large specific surface area, for example alumina.

The catalyst B used for the reaction for oxidizing hydrocarbons is chosen from catalysts well known in the art for their activity and preferably their selectivity as regards to reactions for oxidizing hydrocarbons. In particular, reforming and steam reforming catalysts used in the petrochemical and oil-refining field may be used according to the invention.

Such an arrangement has many advantages in relation to structures known at the present time, among which:
the introduction of the catalytic system into the porosity of the support advantageously makes it possible to increase considerably the developed surface area of the catalyst accessible to contaminants, and consequently the probability of contact and exchanges between reactive species,
the support constitutes, according to the invention, either the electron-conductor C, or the ion-conductor D, or the ion- and electron-conductors C and D. This arrangement advantageously makes it possible to provide the electrochemical system with an unlimited quantity of charged species (ions and/or electrons), in this way appreciably improving the capacities of the system,
a limited number of the constituents of the system should be deposited on the support, which considerably reduces the dependence of the performance of the system relative to the deposition conditions of the catalyst on the support,
good chemical compatibility between the porous inorganic material constituting the support and the catalytic system,
a reduction in production costs, linked to a simpler deposition method on account of the small number of compounds to be deposited,
an increase in catalytic efficiency, it being possible for a greater quantity of catalysts to be deposited on account of the limited number of constituents that have to be deposited in the porosity of the matrix.

The electrochemical system according to the invention may be implemented in various possible ways, according to any known technique of the art:

According to a first procedure, the ion-conducting and/or electron-conducting porous inorganic material constituting or covering the structure is obtained by a doping, reducing or oxidizing treatment of a porous material that is initially not, or only slightly, an ion-conductor and/or an electron-conductor.

According to an alternative procedure, the ion-conducting and/or electron-conducting porous inorganic material may be obtained by mixing a porous material that is initially not, or only slightly, an ion-conductor and/or an electron-conductor with an ion conducting and/or electron-conducting material.

For example, the porous inorganic material includes or consists of an electron-conducting inorganic material of the carbide type, for example SiC, or silicide type, for example MoSi₂, or boride type, for example TiB₂, or of the La; SrₓMnO₃ family or of the gadolinium and cerium mixed oxide type (CGO).

The porous inorganic material may also include or consist of an inorganic material that conducts by the oxygen ion, of the fluorite structure type, for example zirconia stabilized by CaO or by Y₂O₃, mixed gadolinium and cerium oxides, or of a perovskite structure, for example gallate, compounds based on lanthanum of the LaAlO₃ or LaGaO₃ or La₁₋ₓSrₓGa_{1-y}Mg_{y}O₃ type or of the bimevox structure type, for example Bi₂V₁₋ₓMeₓO_{z}, or of the lamox structure type, for example La₂Mo₂O₉, or furthermore of the apatite structure, for example Me₁₀(XO₄)₆Y₂, or of the mixed gadolinium and cerium oxide type (CGO). CGO has the advantage of being at the same time an ion-conductor and an electron-conductor.

The porous inorganic material may include or consist of a proton-conducting inorganic material of the perovskite type, for example SrCe₁₋ₓMₓO_{3-α} where M is a rare earth, typically the compound SrCeₓYb₁₋ₓO_{3-α}, or of the BaCe₁₋ₓMₓO_{3-α} type, for example the compound BaCeO₃, or furthermore a compound of the LaₓSr₁₋ₓScO_{3-α} family, for example La_{0.9}Sr_{0.1}ScO_{3-α}.

According to one possible procedure, the porous inorganic material is based on silicon carbide SiC, preferably recrystallized at a temperature of between 2100 and 2400° C. In particular, the inorganic material may be SiC-based doped for example with aluminum or nitrogen, and in such a way that its electron resistivity is preferably less than 20 ohm·cm, even more preferably less than 15 ohm·cm, and in a more preferred manner less than 10 ohm·cm at 400° C. The expression “based on the same material” is understood within the context of the present description to mean that the material consists of at least 25% by weight, preferably at least 45% by weight and in a much preferred manner at least 70% by weight of said material.

The porous inorganic material may also include or consist of a mixture of silicon carbide, possibly doped, and at least one inorganic material that is conductive by the oxygen ion, for example with a fluorite structure (for example zirconia stabilized with CaO or with Y₂O₃, mixed gadolinium and cerium oxides), or with a perovskite structure (gallate, compounds based on lanthanum, for example LaAlO₃ or LaGaO₃ or La₁₋ₓSrₓGa_{1-y}Mg_{y}O₃, or of the bimevox structure (for example Bi₂V₁MeₓOₓ), or of the lamox structure type (for example La₂Mo₂O₉), or of the apatite structure (for example Me₁₀(XO₄)₆Y₂).

According to another embodiment, the porous inorganic material includes or consists of a mixture of silicon carbide, possibly doped, and at least one proton-conducting inorganic material, for example of the perovskite type (for example SrCe₁₋ₓMₓO_{3-α}, where M is a rare earth, for example the compound SrCeₓYb₁₋ₓO_{3-α}) or of the BaCe₁₋ₓMₓO_{3-α} type (for example the compound BaCeO₃), or furthermore a compound of the LaₓSr₁₋ₓSCO_{3-α} family (for example La_{0.9}Sr_{0.1}SCO_{3-α}).

In another possible embodiment, the porous inorganic material includes or consists of silicon carbide, possibly doped, in the porosity of which is deposited a mixture of the reduction catalyst A, the oxidation catalyst B and at least one inorganic material D that conducts by the oxygen ion, for example with a fluorite structure (such as zirconia stabilized with CaO or with Y₂O₃, or mixed gadolinium and cerium oxides), or with a perovskite structure (gallate, compounds based on lanthanum of the LaAlO, or LaGaO₃ or La₁₋ₓSrₓGa_{1-y}Mg_{y}O₃ type, or of the bimevox structure type (for example Bi₂V₁₋ₓMeₓOₓ), or of the lamox structure type (for example La₂Mo₂O₉), or of the apatite structure (for example Me₁₀(XO₄)₆Y₂).

According to another procedure, the porous inorganic material includes or consists of silicon carbide, possibly doped, in the porosity of which is deposited a mixture of the reduction catalyst A, the oxidation catalyst B and at least one proton-conducting inorganic material D, for example of the perovskite type (for example SrCeₓMₓO_{3-α}, where M is a rare earth, for example the compound SrCeₓYb₁₋ₓO_{3-α}) or of the BaCe₁₋ₓO_{3-α} type (for example the compound BaCeO₃), or furthermore a compound of the LaₓSr₁₋ₓScO_{3-α} family (for example La_{0.9}Sr_{0.1}ScO_{3 α}).

The present invention more particularly finds an application in structures used for the purification and filtration of an exhaust gas from a diesel engine. Such structures, generally denoted by the term particulate filters, comprise at least one and preferably a plurality of monolithic honeycomb blocks. As against the previously described purification devices, in such filters the said block or blocks comprise an assembly of adjacent conduits or channels with axes parallel to each other, separated by porous walls, closed by stoppers at one or the other of their ends in order to delimit inlet conduits opening along a face for the admission of gases and outlet conduits opening along a face for the evacuation of gases, so that the gas passes through the porous walls. Examples of such structures, assembled or unassembled are for example described in publication EP 0 816 065, EP 1 142 619, EP 1 306 358 or furthermore EP 1 591 430.

In such filtering structures, the gases are forced to pass through the walls. Work carried out by the applicant has shown that the use of an electrochemical catalyst system such as previously described surprisingly permits on the one hand very good conversion of contaminant species without substantially increasing the loss of pressure brought about by the introduction of the filter on the exhaust line.

Too low a porosity of the material constituting the filtering walls leads to too high a pressure loss. Too high a porosity of the material constituting the filtering walls leads to insufficient filtration efficiency.

Such a system moreover contributes to an improvement in the regeneration efficiency of the filter by encouraging a greater degree of oxidation of soot.

The invention and its advantages will be better understood on reading the non-limiting embodiments and the following examples:

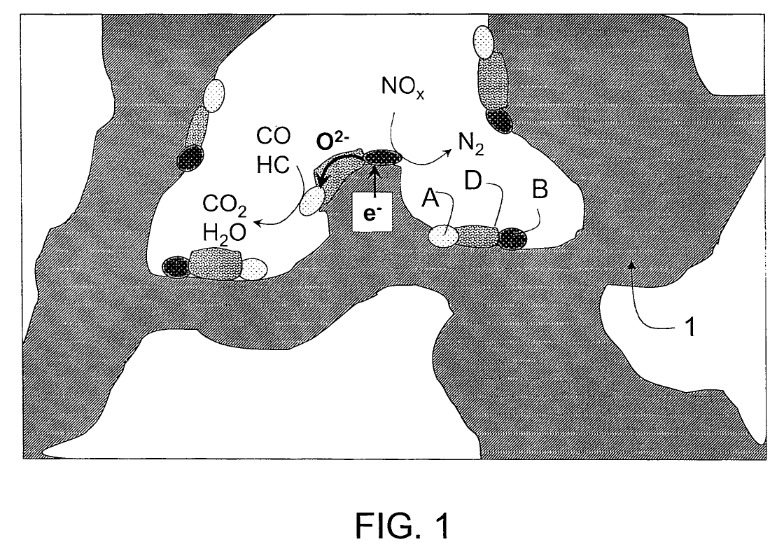

FIG. 1 is a schematic representation in section of a wall portion for example of a catalytic filter according to a first embodiment of the invention, incorporating a first electrochemical catalysis system in its porosity.

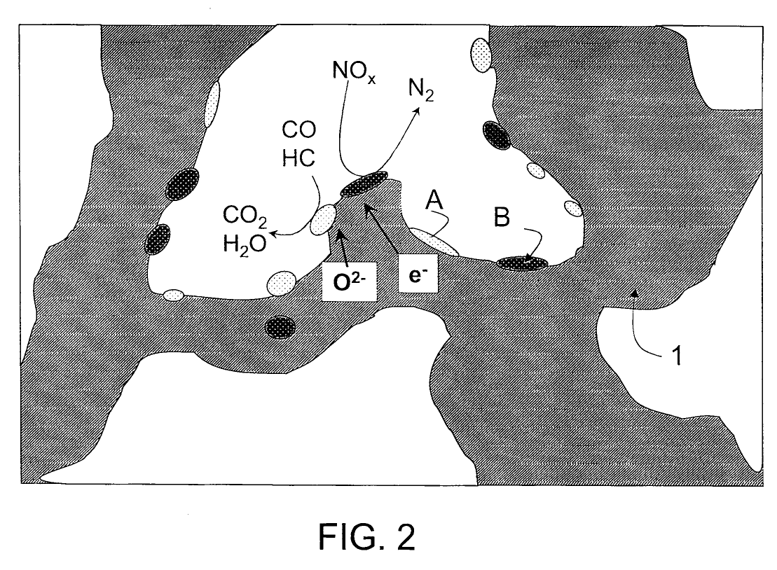

FIG. 2 is a schematic representation in section of a wall portion, for example of a catalytic filter according to a second embodiment of the invention, incorporating a second electrochemical catalyst system in its porosity.

In the embodiment shown in FIG. 1, the material constituting the walls of the filter consists of an electron-conducting material, for example SiC doped with alumina Al, of which the mercury porosity is typically close to 45%. An electrochemical catalysis system has been deposited in the porosity of the support according to known techniques, typically by impregnation, comprising:
the reduction catalyst A enabling NOₓ to be reduced to N₂,
and the oxidation catalyst B that permits oxidation of hydrocarbons HC and CO into CO₂ and H₂O, according to well-known catalytic reactions,
an oxygen ion O² ion-conductor D for example of the YZS type (Yttria Stabilized Zirconia).

The catalyst A typically consists of an active principle including for example precious metals chosen from Pt, Pd, Rh, preferably adsorbed on the surface of a powder with a high specific surface area, for example alumina.

According to a possible but not obligatory embodiment, the catalyst A may include or be associated with a material adsorbing NOₓ, for example a compound of alkali metals or alkaline earth metals or of the rare earths.

According to this embodiment, the electrons necessary for the reaction for reducing NOₓ are advantageously directly provided by the support consisting of the electron-conductor SiC, which makes it possible to ensure the functioning of the cell with a substantially constant quantity of electrons that is not limited by the size of the solid electrolyte. Surprisingly, as will be explained hereinafter, the improved degree of purification of contaminated gases has been obtained according to this procedure, although the electron-conduction of the material constituting the support is relatively low, compared with the electron conductivity of a metal.

O²⁻ anions, also necessary for the reaction for reducing Noₓ, are provided by the ion-conductor D, that is itself in ionic contact with the oxidation catalyst B.

The catalyst B typically consists of an active principle including precious metals (Pt, Pd, Rh) typically deposited by adsorption on the surface of a powder with high specific surface area, for example based on zirconium and cerium oxide.

According to one possible, non-obligatory embodiment, the catalyst B may include or be associated with a material adsorbing hydrocarbons, for example of the zeolite type.

In the embodiment shown schematically in FIG. 2, the material constituting the walls of the filter is an electron-conductor and ion-conductor by the O²⁻ ion.

This time an electrochemical catalysis system has been deposited in the porosity of the support comprising only the reduction catalyst A enabling NOₓ to be reduced into N₂ and the oxidation catalyst B enabling hydrocarbons HC and CO to be oxidized into CO₂ and H₂O. As indicated in FIG. 2, the particles of the catalysts A and B are distributed randomly in the porosity of the support material and in contact therewith. In such a configuration, the support acts as a solid electrolyte and enables O² ions to be provided independently that are necessary for the reduction of hydrocarbons and CO and also provides electrons necessary for the oxidation of NOₓ.

This embodiment presents many advantages:
electrons necessary for the reaction for reducing NOₓ as well as the anions necessary for the reaction for oxidizing HC and CO are advantageously directly provided by the support, which makes it possible to ensure the functioning of the cell with a virtually constant quantity of conducting species that are not limited by the size of the solid electrolyte or electrolytes,
the oxidation and reduction reactions of the electrochemical system function virtually independently, on account of this,
the functioning of the electrochemical catalysis system is improved since all the particles of the catalysts A and B are active: connection between the four constituents A, B, C and D constituting the electrochemical system is inevitable formed, whatever the relative disposition of the particles A and B in the porosity of the material constituting the walls.

In the embodiment illustrated in FIGS. 1 and 2, ionic conduction is ensured by an ion-conducting material through the O² ion. Of course, without departing from the scope of the invention, any other material providing this type of conduction or conduction by migration of other ions (cations or anions) may be used, particularly materials known for their proton conductivity, or by the carbonate ion, as described in U.S. Pat. No. 6,878,354.

The effects obtained for the embodiment illustrated in FIG. 1 have been measured and quantified according to the following example.

### EXAMPLE

First of all, a ceramic filter assembled in SiC, of which the open porosity of the filtering walls was close to approximately 40%, was synthesized according to well-known techniques. Synthesis was carried out under conditions enabling the dopant Al to be incorporated in a weight proportion of approximately 200 ppm. Such doping enabled a structure to be obtained having substantially improved electron conductivity, that is to say a resistivity less than 10 ohm·cm at 400° C.

More precisely, the filtering structure was obtained by assembling filtering elements made of silicon carbide, first of all extruded, dried and then fired according to well-known techniques and bonded by a jointing cement according to techniques described for example in patent EP 1 142 619. The filtering parts were characterized by an assembly of adjacent conduits or channels with axes parallel to each other separated by porous walls, closed by stoppers at one or the other of their ends in order to delimit inlet conduits opening along a face for the admission of gases and outlet conduits opening along a face for the evacuation of gases, so that the gas passes through the porous walls.

Two fractions of silicon carbide grains were initially used in this example with an Al content by weight of approximately 200 ppm. A first fraction had a median diameter greater than 5 μm and 50 μm, at least 10% by weight of the grains making up this fraction having a diameter greater than 5 μm. The second fraction had a median grain diameter less than 5 μm. Both fractions were mixed in a ratio by weight equal to 1 with a temporary binder of the methyl cellulose type and a polyethylene organic porogenic agent.

The main geometric characteristics of the filter obtained in this way are given in table 1:

TABLE 1

| | |
|---|---|
| Geometry of the channels | Square |
| Density of the channels | 180 cpsi |
| | (channels per square inch, |
| | 1 inch = 2.54 cm, that is |
| | approximately 28 |
| | channels/cm²) |
| Thickness of the walls | 350 μm |
| Length | 15.2 cm |
| Width | 3.6 cm |
| Volume | 2.47 liters |
| Porosity | Approximately 47% |
| Median diameter of the | Approximately 15 μm |
| pores | |

The catalysts A and B and the ion-conducting compound D were synthesized in the following manner:

### Catalyst A:

500 g of a gamma alumina powder marketed by Sasol was impregnated with an aqueous solution of Ba nitrate. The whole was then dried at 110° C. and then calcined at 600° C. for 3 hours in air, so as to obtain a powder of alumina grains coated with BaO. This powder was then impregnated, according to well-known techniques, with an aqueous solution of platinum dinitrodiamine chloride and then dried at 110° C. for three hours, and finally brought to 250° C. for 2 hours so as to obtain a catalyst A.

### Catalyst B

300 grams of a zeolite powder of the Mordenite type were suspended in a solution of zirconium hydroxynitrate, to which an aqueous ammonia solution was added so as to adjust the pH to at least 8. The solution was then filtered, dried at 110° C. and then calcined at 500° C. for one hour. The powder obtained in this way was dispersed in an aqueous solution of rhodium nitrate and then filtered and dried at 400° C. for one hour in order to obtain the catalyst B.

### Ion-Conductor D:

The ion-conductor D used was a YSZ powder (basic TZ grade of zirconia powder) marketed by Tosoh.

The particle size of the catalyst powders A, B and of the ion-conductor D, was adapted to the porosity of the porous ceramic body.

Secondly, the untreated filter structure was then immersed in a bath of an aqueous solution containing powders of the catalysts A, B and the compound D, in proportions enabling approximately 2% by weight of each component to be obtained on the support, based on the total weight of support.

The filter was impregnated with a solution according to a method similar to that described in U.S. Pat. No. 5,866,210. The filter was then dried at approximately 150° C. and then heated to a temperature of approximately 500° C. A catalytic filter according to the invention was obtained in this way.

The properties of the catalytic filter obtained in this way were tested according to various tests:

### 1°) NOₓ Conversion Test:

The performance of the filter was measured at a temperature of 400° C. by means of two synthetic gas mixtures according to table 2, characteristic of exhaust gases during the functioning of a diesel motor with a lean mixture (mixture 1) and during the functioning of a diesel engine with a rich mixture (mixture 2).

TABLE 2

| Constituent | Mixture 1 (lean) | Mixture 2 (rich) |
|---|---|---|
| HC (ppm by volume) | 1000 | 1000 |
| CO (ppm by volume) | 600 | 600 |
| NOₓ (ppm by volume) | 500 | 500 |
| CO₂ (% by volume) | 6 | 6 |
| H₂O (% by volume) | 10 | 10 |
| O₂ (% by volume) | 10 | 0.5 |
| N₂ | Remainder | Remainder |

The test was carried out in the following way: the lean gas mixture 1 first of all passed over the catalyzed filter held in an electric oven at 400° C. Every two minutes, the composition of the gases was switched over to the rich gas mixture 2 for 5 seconds, before being switched back to the mixture 1 and so on. The composition of gases leaving the oven was analyzed after stabilization so as to know the quantity of NOₓ converted.

The test that has just been described was carried out under the same conditions on a filter only containing the catalysts A and B in the same proportions, and on the electrocatalyzed filter containing the components A, B and D, of which the synthetic method has been previously described. The results are given in table 3.

TABLE 3

| | | Electrocatalyzed |
|---|---|---|
| | Filter without D | filter |
| Degree of conversion | 40 | 50 |
| of NOₓ | | |
| (% by volume) | | |

### 2°) Pressure Loss Test

The two previous filters (non-electrocatalyzed and electrocatalyzed) were mounted on an engine test bed with an engine speed of 3000 rpm and a torque of 50 Nm in order to obtain a soot charge in the filter of 7 g/L of filter.

The pressure loss was measured on the filter according to the techniques of the art, for an air flow rate of 600 m³/h in a stream of ambient air. Pressure loss is understood to mean within the context of the present invention the differential pressure existing between the upstream and downstream of the filter.

NOₓ conversion tests were carried out under the same conditions as previously. It was verified that the conversion rates were similar.

Pressure loss was once again measured on filters after a second NOₓ conversion test. Surprisingly, it was observed that the pressure loss after this second conversion test was smaller on the filter according to the invention than on the non-electrocatalyzed filter. Although this cannot be considered as any theory, such a reduction could be explained by the unexpected action of the electrochemical system according to the invention on the oxidation of soot.

The results are given in table 4.

TABLE 4

| Pressure loss | | Electrocatalyzed |
|---|---|---|
| (measured in mbar) | Filter without D | filter |
| Before loading with | 51 | 53 |
| soot | | |
| After loading with | 101 | 102 |
| soot at 7 g/L | | |
| After second NOₓ | 102 | 92 |
| conversion test | | |

1: A structure, preferably a honeycomb structure, for the purification of a contaminated gas, for example an exhaust gas from a diesel or gasoline engine, incorporating an electrochemical system for treating said gas, consisting of:
a catalyst A for reducing contaminant species of the NOₓ type,
a catalyst B for oxidizing hydrocarbons HC,
an electron-conducting compound C,
an ion-conducting compound D,
said catalysts A and B being in electronic contact via the compound C and in ionic contact via the compound D,
said structure being characterized in that it consists of, or is covered by, at least one ion-conducting and/or electron-conducting porous inorganic material so that:
the catalysts A and B are deposited in the porosity of the inorganic material,
the electron-, ion- or ion- and electron-conducting inorganic material constitutes respectively the element C, the element D, or the sum of the elements C and D of said electrochemical system.

2: The structure as claimed in claim 1, characterized in that the porous inorganic material is an electron-conductor and constitutes the element C of the electrochemical system.

3: The structure as claimed in claim 1, characterized in that the porous inorganic material is an electron-conductor and ion-conductor and constitutes the elements C and D of the electrochemical system.

4: The structure as claimed in claim 1, characterized in that the ion-conducting or electron-conducting porous inorganic material is obtained by a doping, reducing or oxidizing treatment of a porous material that is initially not, or only slightly, an ion-conductor and/or an electron-conductor.

5: The structure as claimed in claim 1, characterized in that the ion-conducting and/or electron-conducting porous inorganic material is obtained by mixing a porous material that is initially not, or only slightly, an ion-conductor and/or an electron-conductor with an ion conducting and/or electron-conducting material.

6: The structure as claimed in claim 1, characterized in that the porous inorganic material includes or consists of an electron-conducting inorganic material of the carbide type, for example SiC, or silicide type, for example MoSi₂, or boride type, for example TiB₂, or of the La₁₋ₓSrₓMnO₃ family or of the gadolinium and cerium mixed oxide CGO type.

7: The structure as claimed in claim 1, characterized in that the porous inorganic material includes or consists of an inorganic material that conducts by the oxygen ion, of the fluorite structure type for example, zirconia stabilized by CaO or by Y₂O₃, mixed gadolinium and cerium oxides, or of a perovskite structure of the gallate type, compounds based on lanthanum, for example LaAlO₃ or LaGaO₃ or La₁₋ₓSrₓGa_{1-y}Mg_{y}O₃ type or of a bimevox structure, for example Bi₂V₁₋ₓMeₓO₂, or of a lamox structure, for example La₂Mo₂O₉, or furthermore of the apatite structure, for example Me₁₀(XO₄)₆Y₂.

8: The structure as claimed in claim 1, characterized in that the porous inorganic material includes or consists of a proton-conducting inorganic material of the perovskite type, for example SrCe₁₋ₓMₓO_{3-α} where M is a rare earth, for example the compound SrCeₓYb₁₋ₓO_{3-α}, or of the BaCe₁₋ₓMₓO_{3-α} type, for example the compound BaCeO₃, or furthermore a compound of the LaₓSr₁₋ₓScO_{3-α} family, for example La_{0.9}Sr_{0.1}Sc_{3-α}.

9: The structure as claimed claim 1, characterized in that the porous inorganic material is based on silicon carbide SiC.

10: The structure as claimed in claim 9, characterized in that the inorganic material is based on SiC, doped for example with aluminum or nitrogen, and in such a way that its electron resistivity is less than 20 ohm·cm at 400° C.

11. The structure as claimed in claim 9, characterized in that the porous inorganic material includes or consists of a mixture of silicon carbide, possibly doped, and at least one inorganic material that is conductive by the oxygen ion, for example with a fluorite structure or a perovskite structure or a bimevox structure or a lamox structure or an apatite structure or at least one proton-conducting inorganic material, for example of the perovskite type, or of the BaCe₁₋ₓMₓO_{3-α} type, or furthermore a compound of the LaₓSr₁₋ₓScO_{3-α} family.

12: The structure as claimed in claim 9, characterized in that the porous inorganic material includes or consists of silicon carbide, possibly doped, in the porosity of which is deposited a mixture of the reduction catalyst A, the oxidation catalyst B and at least one inorganic material that conducts by the oxygen ion, for example with a fluorite structure, or of the perovskite structure type or of the bimevox structure or of the lamox structure or of the apatite structure or of at least one proton-conducting inorganic material, for example of the perovskite type or of the BaCe₁₋ₓMₓO_{3-α} type, or furthermore a compound of the LaₓSr₁₋ₓScO_{3-α} family.

13: The structure as claimed in claim 1 for the purification and filtration of an exhaust gas of a diesel engine, comprising at least one and preferably a plurality of monolithic honeycomb blocks, said block or blocks comprising an assembly of adjacent conduits or channels with axes parallel to each other, separated by porous walls, closed by stoppers at one or the other of their ends in order to delimit inlet conduits opening along a face for the admission of gases and outlet conduits opening along a face for the evacuation of gases, so that the gas passes through the porous walls.
